(19) United States
(12) Patent Application Publication
(10) Pub. No.: US 2025/0165797 A1
(43) Pub. Date: May 22, 2025

(54) REINFORCEMENT LEARNING-BASED SYSTEM AND METHOD FOR ADAPTIVELY ADJUSTING COMPUTING CAPACITY

(71) Applicant: MEDIATEK INC., Hsinchu City (TW)

(72) Inventors: Nien-Hsien LIN, Hsinchu City (TW); Cheng-Kuan HOH, Hsinchu City (TW); Yen-An SHIH, Hsinchu City (TW); Cheng Han TSAI, Hsinchu City (TW); Cheng-Che CHEN, Hsinchu City (TW)

(21) Appl. No.: 18/953,271

(22) Filed: Nov. 20, 2024

Related U.S. Application Data
(60) Provisional application No. 63/601,858, filed on Nov. 22, 2023.

(51) Int. Cl. G06N 3/092

(52) U.S. Cl. CPC G06N 3/092

(57) ABSTRACT

A reinforcement learning-based system for adaptively adjusting computing capacity is provided. The system includes an environment module and an agent module. The environment module is configured to collect environment information, including the actual power consumption and one or more power-related metrics, from an application environment. The environment module is further configured to determine a reward value based on the actual power consumption and the expected power consumption, and determine state data based on the one or more power-related metrics. The agent module is configured to receive the reward value and the state data from the environment module, and determine an adjustment action based on the reward value and the state data. The adjustment action involves adjusting the computing capacity and is dynamically executed by the application environment.

### CROSS REFERENCE TO RELATED APPLICATIONS

This application claims the benefit of U.S. Provisional Application No. 63/601,858, filed Nov. 22, 2023, the entirety of which is/are incorporated by reference herein.

### BACKGROUND OF THE INVENTION

### Field of the Invention

The present disclosure relates to the techniques of reinforcement learning and computing capacity adjustment, and in particular to a reinforcement learning-based system and method for adaptively controlling computing capacity.

### Description of the Related Art

In modern computing systems, managing the balance between performance and power consumption has become increasingly critical, particularly in long-duration, high-load applications such as gaming. These applications often push the system to operate at its maximum capacity for extended periods, leading to excessive heat generation. To prevent damage or instability caused by overheating, systems frequently engage in thermal throttling, whereby the allocation of computing resources is automatically adjusted to lower power consumption and temperature. While thermal throttling protects the system, it may also result in a noticeable decrease in performance, creating a significant challenge for maintaining consistent application responsiveness.

Existing approaches to power management in high-load environments often attempt to delay overheating by reducing application performance. These methods prioritize extending the time before thermal throttling occurs but fail to achieve a balanced trade-off between performance and power consumption. As a result, system resources are often underutilized, and application performance might be over-sacrificed prematurely, leading to suboptimal user experiences.

The inherent dilemma of managing application performance and power consumption remains a significant challenge in current systems. The relationship between power consumption and application performance is highly complex and difficult to fully understand. When faced with dynamic and intensive workloads, static configurations fail to effectively adapt, leading either to inefficient power use or significant performance degradation.

Therefore, there is a need for a dynamic, intelligent solution that can adaptively optimize computing capacity by taking into account the complex relationship between power consumption and performance over time, particularly in scenarios prone to prolonged high-load operation and thermal constraints.

### BRIEF SUMMARY OF THE INVENTION

An embodiment of the present disclosure provides a reinforcement learning-based system for adaptively controlling computing performance. The system includes an environment module and an agent module. The environment module is configured to collect environment information, including the actual power consumption and one or more power-related metrics, from an application environment. The environment module is further configured to determine a reward value based on the actual power consumption and the expected power consumption, and determine state data based on the one or more power-related metrics. The agent module is configured to receive the reward value and the state data from the environment module, and determine an adjustment action based on the reward value and the state data. The adjustment action involves adjusting the computing capacity and is dynamically executed by the application environment.

In an embodiment, the agent module determines the adjustment action by calculating a step size based on the reward value and the state data, and adding the step size to the previous adjustment action.

In an embodiment, the agent module calculates the step size based on a power-capacity correlation, the reward value, and the state data.

In an embodiment, the environment module determines the reward value by calculating the discrepancy between the actual power consumption and the expected power consumption and using the discrepancy as the reward value.

In an embodiment, the one or more power-related metrics includes at least one of total system power consumption and CPU frequency ratio.

An embodiment of the present disclosure provides a reinforcement learning-based method for adaptively adjusting computing capacity. The method is applied in a computing system that includes an environmental module and an agent module. The method includes, by the environment module, collecting environment information, including the actual power consumption and one or more power-related metrics, from an application environment, determining a reward value based on the actual power consumption and the expected power consumption, and determining state data based on the one or more power-related metrics. The method further includes, by the agent module, receiving the reward value and the state data from the environment module, and determining an adjustment action based on the reward value and the state data. The adjustment action involves adjusting the computing capacity and is dynamically executed by the application environment.

Embodiments of the present disclosure provides an adaptive reinforcement learning-based system that optimizes computing capacity in high-load, long-duration applications, such as gaming, while maintaining a balanced trade-off between performance and power consumption. By leveraging real-time data, the system dynamically adjusts computing capacity to prevent overheating without overly sacrificing application performance. This dynamic adjustment mechanism effectively extends the time before thermal throttling occurs, minimizing performance degradation in high-intensity applications. As a result, the system provided herein improves both the user experience and system efficiency by ensuring a balanced trade-off between power consumption and system performance.

### BRIEF DESCRIPTION OF THE DRAWINGS

The present disclosure can be more fully understood by reading the subsequent detailed description and examples with references made to the accompanying drawings. Additionally, it should be appreciated that in the flow diagram of the present disclosure, the order of execution for each blocks can be changed, and/or some of the blocks can be changed, eliminated, or combined.

FIG. 1 is the architecture diagram of a reinforcement learning-based system for adaptively adjusting computing capacity, according to an embodiment of the present disclosure.

FIG. 2 is the flow diagram of a reinforcement learning-based method for adaptively adjusting computing capacity, according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The description for the embodiments of the method is also applicable to the embodiments of the device or system, and vice versa.

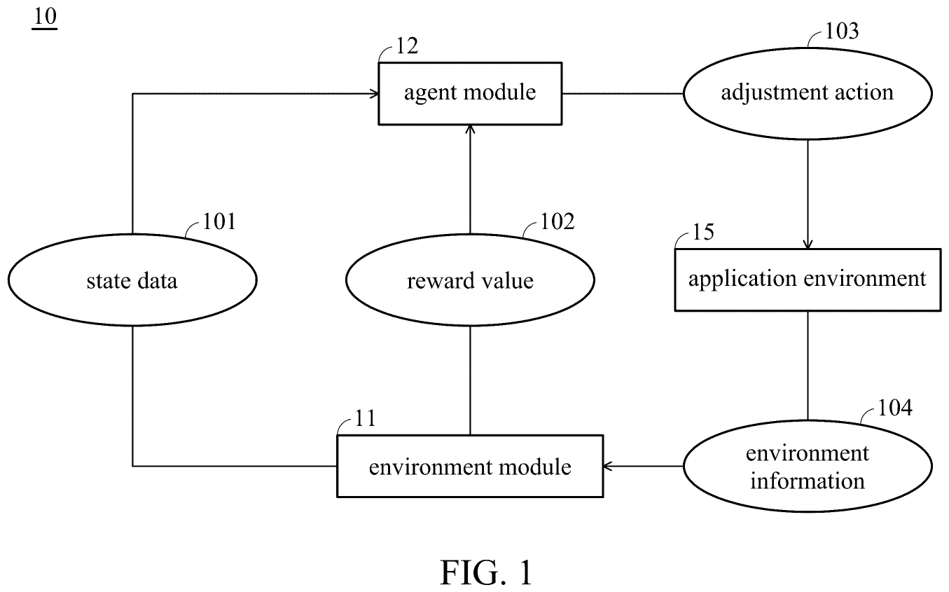

FIG. 1 is the architecture diagram of a reinforcement learning-based system 10 for adaptively adjusting computing capacity, according to an embodiment of the present disclosure. As shown in FIG. 1, the system 10 includes the environment module 11 and the agent module 12. Additionally, FIG. 1 further shows the interactions between an application environment 15 with the environment module 11 and the agent module 12. The application environment 15 can be regarded as being included in the system 10, or being external to the system 10, the present disclosure is not limited thereto.

The system 10 can be a computing system implemented using either general-purpose processing units or special-purpose hardware circuitry. In an embodiment, the system 10 can be a general-purpose processor, microprocessor, or microcontroller, which loads a program or instruction set from the storage unit of an electronic device (e.g., computer, mobile phone, or tablet) to perform the functions of the environment module 11 and the agent module 12. In another embodiment, the system 10 may incorporate one or more integrated circuits, such as system-on-chip (SoC), application-specific integrated circuits (ASICs) and/or field programmable gate arrays (FPGAs), which are dedicated to executing the functions of the environment module 11 and the agent module 12.

The application environment 15 refers to the collection of software, hardware, and configuration settings in which an application (e.g., games, simulations, data analytics, machine learning, video editing, or 3D rendering) operates. The application environment 15 may include computing resources and dependencies required to run the application effectively and efficiently, such as processing units (e.g., CPU, GPU, TPU, NPU), memory units (e.g., RAM, ROM, DRAM, SRAM, flash memory), BIOS, operating systems (e.g., Windows, Mac OS, Linux, UNIX), runtime environment (e.g., Java virtual machine, Node.js, .NET Framework), database, networking resources, security settings and configuration settings.

The environment module 11 is configured to collect environment information 104 from the application environment 15. Based on the collected environment information 104, the environment module 11 determines a reward value 102 using a reward function and then outputs the state data 101 and the reward value 102 to the agent module 12. The agent module 12 receives the output from the environment module 11, including the reward value 102 and the state data 101. Based on the received reward value 102 and state data 101, the agent module 12 determines an adjustment action 103, which is then fed back to the application environment 15. The application environment 15 executes the adjustment action 103, causing the environment module 11 to collect updated environment information 104 as a result of the adjustment action 103.

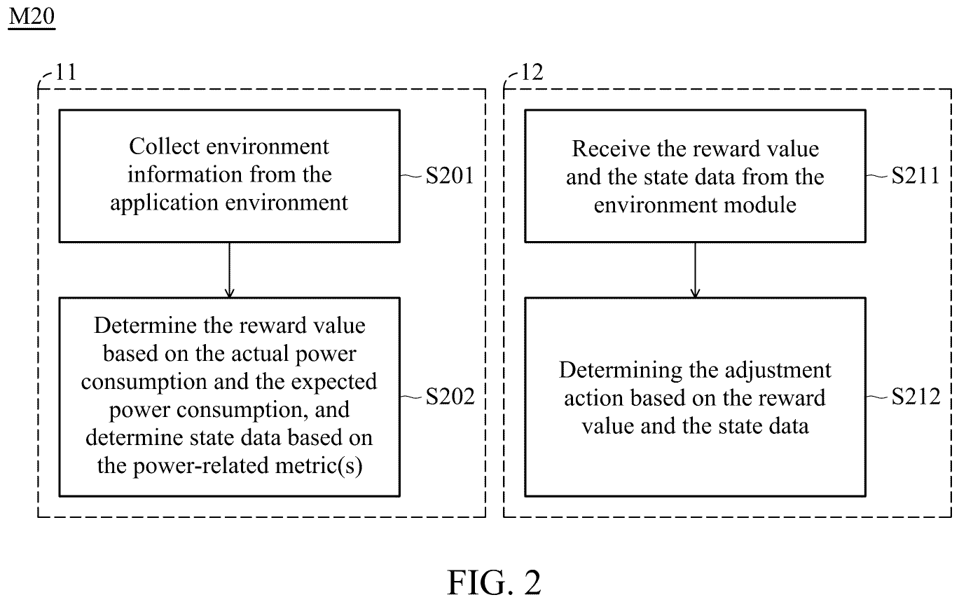

As briefly introduced, the closed-loop interaction between the environment module 11, the agent module 12, and the application environment 15 forms a continuous cycle of adaptation and optimization in response to varying conditions over time. Further details regarding the operational behaviors of the environment module 11 and the agent module 12 will be elaborated with reference to FIG. 2 hereinafter.

FIG. 2 is the flow diagram of a reinforcement learning-based method M20 applied in the system 10 of FIG. 1, according to an embodiment of the present disclosure. As shown in FIG. 2, method M20 includes steps S201 and S202 executed by the environment module 11, and steps S211 and S212 executed by the agent module 12. In view of the strong correlation between FIG. 1 and FIG. 2, it is recommended to refer to FIG. 2 and FIG. 1 collectively for a clearer understanding of the embodiments disclosed herein.

In step S201, the environment module 11 collects environment information 104 from the application environment 15. Then, the environment module 11 proceeds to step S202.

The environment information 104 collected in step S201 includes actual power consumption, which refers to the real-time measurement of power consumed by the system during operation. Actual power consumption can be collected through various approaches, such as sensors or monitoring tools integrated into the hardware, including power meters, energy management systems, or built-in features of the processing units (e.g., CPU, GPU) that track power usage. Additionally, it can be obtained from the battery or power supply unit (PSU) through their respective drivers, which monitor and report the power being drawn by the system.

Besides the actual power consumption, the environment information 104 collected in step S201 further includes other power-related metric(s) associated with the application environment 15. These power-related metric(s) can include environmental factors related to system power consumption, such as CPU frequency, CPU/GPU utilization rates, voltage levels, thermal conditions, and average frame per second (FPS). Metrics such as CPU frequency and utilization can be obtained directly from the processing units via performance counters or system-level APIs that monitor resource usage. Voltage levels and thermal conditions can be retrieved from sensors integrated into the motherboard, CPU, GPU, or power supply unit (PSU), which continuously monitor these parameters. In addition, power-related metrics may also include power supply efficiency or battery discharge rates, which can be accessed through drivers that communicate with the power supply unit or battery management systems.

In an embodiment, the power-related metrics include at least one of total system power consumption and CPU frequency ratio. These two metrics are highly representative of the system's performance and energy efficiency because they directly reflect the relationship between the power being consumed and the computational workload. Specifically, total system power consumption refers to the overall amount of power used by the system, which can be obtained through hardware sensors embedded in the power supply unit (PSU), or by monitoring power draw through the system's battery via drivers that track battery discharge rates. This metric provides a comprehensive view of the energy usage across all system components, including the CPU, GPU, memory, and other peripherals. On the other hand, the CPU frequency ratio represents the current operating frequency of the CPU as a proportion of its maximum possible frequency. This ratio can be obtained from performance monitoring counters or system management interfaces (e.g., ACPI) that provide real-time information about the CPU's clock speed relative to its maximum capacity. By tracking this ratio, the system can assess how much computational power is being utilized compared to the maximum available.

In step S202, the environment module 11 determines the reward value 102 based on the actual power consumption and the expected power consumption. Specifically, a reward function is used to calculate the reward value, with the actual power consumption and the expected power consumption as the input parameters of the reward function. The expected power consumption, serving as optimal power consumption target for preventing thermal throttle, can be developer-defined, user-defined, or determined through supervised learning or rule-based algorithms, but the present disclosure is not limited thereto.

The reward function quantifies the desirability of the previous actions determined by the agent module 12. The environment module 11 uses the reward value 102 to provide a numerical signal to the agent module 12, guiding the agent module 12 to make better decisions over time. In principle, the reward function is designed to produce a higher reward value 102 for desirable states of the application environment 15. Without departing from this principle, embodiments of the present disclosure are not limited to a particular design of the reward function.

In an embodiment, the reward value 102 is determined by calculating the discrepancy between the actual power consumption and the expected power consumption. This discrepancy represents how closely the actual power consumption aligns with the expected power consumption under current workload conditions. An exemplary approach to calculate the discrepancy is to subtract the actual power consumption from the expected power consumption and then take the absolute value, but the present disclosure is not limited thereto. Other mathematical metrics for measuring the discrepancy can also be used. Then, this discrepancy is used as the reward value 102.

Additionally, in step S202, the environment module 11 further determines the state data 101 based on the power-related metric(s), such as CPU frequency, CPU/GPU utilization rates, voltage levels, thermal conditions, and average frame per second (FPS). The state data 101 can be set as any one of these power-related metrics or derived from any combination thereof, such as by calculating their sum, product, weighted average, or any other mathematical expression that integrate their respective contributions, but the present disclosure is not limited thereto. The state data 101 determined in this step is then transferred to the agent module 12.

In step S211, the agent module 12 receives the reward value 102 and the state data 101 from the environment module 11. Then, in step S212, the agent module 12 determines the adjustment action 103 based on the reward value 102 and the state data 101. More specifically, the agent module 12 uses an algorithm to translate the reward value 102 and the state data 101 provided by the environment module 11 into the adjustment action 103. The algorithm optimizes the adjustment action 103 to maximize the cumulative reward over time by continuously learning from the received state data 101 and reward value 102. The algorithm can involve Q-learning, Deep Q Network (DQN), Proximal Policy Optimization (PPO), or Actor-Critic methods, but the present disclosure is not limited thereto. In the optimization algorithm, the reward value 102 may serve as the primary objective for guiding the learning process, indicating how well the system is performing in terms of power efficiency and performance balance. The state data 101, on the other hand, may function as a constraint to ensure that adjustments do not compromise specific system requirements. In an implementation, the state data 101 may include average frames per second (FPS), where the algorithm must ensure that FPS remains above a certain threshold while optimizing power consumption. This interplay between reward value 102 and state data 101 facilitates the agent module 12 to achieve a dynamic balance between efficiency and performance, adapting to varying workload conditions effectively.

The adjustment action 103 involves adjusting the computing capacity and is dynamically executed by the application environment 15. Following the execution of the adjustment action 103, the environment module 11 captures updated environment information 104 from the application environment 15. This updated environment information 104 reflects the effect of the adjustment action 103. As a result, the computing capacity is adaptively adjusted in response to varying system conditions and application performance demands.

In an embodiment, the agent module 12 determines the adjustment action 103 by calculating a step size based on the reward value 102 and the state data 101, and adding the step size to the previous adjustment action 103. The step size represents the extent to which the agent module 12 decides to adjust the computing capacity. A larger step size indicates that adjustment action 103 will result in more significant changes to the computing capacity, whereas a smaller step size results in more gradual adjustments.

In a further embodiment, in addition to the reward value 102 and the state data 101, the agent module 12 also considers the power-capacity correlation to calculate the step size. The power-capacity correlation describes the relationship between the power consumed and the computing capacity of the system. This correlation varies depending on the hardware specifications, such as the architecture, frequency scaling capabilities, and power efficiency of the processing units. For instance, a CPU power curve is a visual representation of the power-capacity correlation, illustrating how power consumption increases with higher CPU frequencies or workloads. By referencing the power-capacity correlation, the agent module 12 can better predict the impact of adjustments to computing capacity on power consumption. This allows the agent module 12 to fine-tune the step size, ensuring that adjustments are made efficiently without causing unnecessary spikes in power usage or compromising performance. As a result, the step size can be dynamically optimized to maintain a balance between power consumption and computing performance.

Embodiments of the present disclosure provides an adaptive reinforcement learning-based system that optimizes computing capacity in high-load, long-duration applications, such as gaming, while maintaining a balanced trade-off between performance and power consumption. By leveraging real-time data, the system dynamically adjusts computing capacity to prevent overheating without overly sacrificing application performance. This dynamic adjustment mechanism effectively extends the time before thermal throttling occurs, minimizing performance degradation in high-intensity applications. As a result, the system provided herein improves both the user experience and system efficiency by ensuring a balanced trade-off between power consumption and system performance.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reinforcement learning-based system for adaptively adjusting computing capacity, comprising:
an environment module, configured to collect environment information, including an actual power consumption and one or more power-related metrics, from an application environment, determine a reward value based on the actual power consumption and an expected power consumption, and determine state data based on the one or more power-related metrics; and
an agent module, configured to receive the reward value and the state data from the environment module, and determine an adjustment action based on the reward value and the state data, wherein the adjustment action involves adjusting the computing capacity and is dynamically executed by the application environment.

2. The system as claimed in claim 1, wherein the agent module determines the adjustment action by calculating a step size based on the reward value and the state data, and adding the step size to a previous adjustment action.

3. The system as claimed in claim 2, wherein the agent module calculates the step size based on a power-capacity correlation, the reward value, and the state data.

4. The system as claimed in claim 1, wherein the environment module determines the reward value by calculating a discrepancy between the actual power consumption and the expected power consumption and using the discrepancy as the reward value.

5. The system as claimed in claim 1, wherein the one or more power-related metrics includes at least one of total system power consumption and CPU frequency ratio.

6. A reinforcement learning-based method for adaptively adjusting computing capacity, applied in a computing system that comprises an environmental module and an agent module, wherein the method comprising:
by the environmental module, collecting environment information, including an actual power consumption and one or more power-related metrics, from an application environment, determining a reward value based on the actual power consumption and an expected power consumption, and determining state data based on the one or more power-related metrics; and
by the agent module, receiving the reward value and the state data from the environment module, and determining an adjustment action based on the reward value and the state data, wherein the adjustment action involves adjusting the computing capacity and is dynamically executed by the application environment.

7. The method as claimed in claim 6, wherein the adjustment action is determined by calculating a step size based on the reward value and the state data, and adding the step size to a previous adjustment action.

8. The method as claimed in claim 7, wherein the step size is calculated based on a power-capacity correlation, the reward value, and the state data.

9. The method as claimed in claim 6, wherein the reward value is determined by calculating a discrepancy between the actual power consumption and the expected power consumption and using the discrepancy as the reward value.

10. The method as claimed in claim 6, wherein the one or more power-related metrics includes at least one of total system power consumption and CPU frequency ratio.
